(19) United States
(12) Patent Application Publication
(10) Pub. No.: US 2024/0295335 A1
(43) Pub. Date: Sep. 5, 2024

(54) APPARATUS AND A METHOD FOR CONTROLLING VENTILATION IN A BUILDING AND GENERATING ELECTRICITY

(71) Applicant: NOBUYOSHI MORIMOTO, Tokyo (JP)

(72) Inventor: NOBUYOSHI MORIMOTO, Tokyo (JP)

(21) Appl. No.: 18/594,420

(22) Filed: Mar. 4, 2024

(30) Foreign Application Priority Data
Mar. 3, 2023 (IN) 202311014501

(51) Int. Cl. F24F 11/00; F24F 7/04

(52) U.S. Cl. CPC F24F 11/0001; F24F 7/04

(57) ABSTRACT

The present invention provides an apparatus for controlling ventilation in a building (100) for converting renewable source of energy into electrical energy. The apparatus comprises a sail member (102) extending from each corner of the building (100) to direct air flow from exterior potion of the building towards interior portion of the building (100). The apparatus also comprises a first tubular member (104) operationally coupled to a windward member of the building (100) to direct the air flow in downward direction. The apparatus also comprises at least a second tubular member (108) coupled to the first tubular member (104) and a third tubular member (110), to increase the air flow received from the first tubular member (104), wherein the increased air flow is utilized to provide electricity to a ventilation mechanism (114) for maintaining and controlling air ventilation of the building (100).

### FIELD OF THE INVENTION

The present invention generally relates to converting renewable source of energy into electrical energy. More specifically, the present invention relates to techniques for controlling ventilation in a building.

### BACKGROUND OF THE INVENTION

The field of air conditioning knows a variety of air distribution devices that are designed to produce a turbulent mixed flow in rooms. The air exits turbulent and almost horizontally from the air distribution device, with a cooling or heating of the air via typically traversed by water as the heat transfer medium and the heat exchanger elements. The air distribution device influences the flow of the ceiling panel. Generally, suspended ceiling structures offer the possibility to arrange air distribution devices of the type described above in a space between the suspended ceiling and the actual ceiling, with the air outlet surface is either in the plane of the suspended ceiling.

Conventionally, there have been a number of know techniques which are related to control indoor temperature, pressure, ventilation rate, and other variables. Such conventional general type are known in the art and are exemplified by the following patents and publication:

DE 20 2006 007 846 U1 describes air distribution device allowing, for example, an approximately horizontal outflow of supply air. For this purpose, the air distribution device has an air inlet surface, an air outlet surface and four inclined walls. The walls are arranged at an acute angle to the air outlet surface. Accordingly, the air distribution device has a truncated pyramid housing shape. The arrangement of the walls enables advantageous turbulent mixed ventilation, with the air at an angle α up to a maximum of 15° being approximately parallel to the plane formed by the air outlet surface, i.e. parallel to the ceiling plane, for example, radially aligning from the center of the air outlet surface has on the outside. However, air flow from multiple directions cannot be utilized with this type of conventional device.

Another air distribution device that works on the principle of a turbulent air system is described in DE 10 2007 008 019 A1. In this air distribution device, too, it is provided that the supply air does not exit perpendicularly to the ceiling, but rather flows through perforations in a perforated plate at an angle that is as flat as possible, so that there is an air flow parallel to the ceiling, which induces the room air. This results in a high power density with good thermal comfort. The perforated sheet metal is formed by a ceiling panel of a grid ceiling or wall cladding. To change the direction of flow, guide elements in the air distribution device are described in said document, which, in addition to the horizontal outflow direction along a ceiling panel, also allow a vertical outflow direction perpendicular to the ceiling panel. This is particularly useful when heating, to prevent warm air from collecting under the ceiling panel or, conversely, to achieve a large penetration depth of the warm air in the room. To cool a room, however, horizontal outflow under the ceiling panel is desirable, as this means that warm and cold air is distributed more evenly in the room and drafts are avoided. The aforementioned air distribution devices have the disadvantage that the supply air is not sufficiently cooled, particularly on very warm days, in order to create a pleasant indoor climate.

Another patent document DE 10 2010 001 319 A1 describes an air distribution device with a canopy ceiling, with the air distribution device also leaving the supply air in a direction parallel to the ceiling and flowing into the room. It is possible for the supply air to flow out above the canopy ceiling in order to cool or heat the supply air using pipes arranged in a meandering pattern on the canopy ceiling. A radial outflow is not desired, as this would require the air outlet to be located centrally in a room. Furthermore, a targeted outflow onto a workplace should be made possible by means of the air outlet, which is why a radial outflow would be disadvantageous. Air conditioning of an entire room is only possible to a limited extent by means of this air distribution device, since it is neither desirable nor possible for the supply air to flow out over a large area.

Thus, the above limitations of numerous innovations in relation to conventional methods of dehumidifying or humidifying air can be expensive, inefficient, lack precision, have an inconveniently large footprint, lack modularity or be difficult to modularize, be slow to respond to changes in humidity, lack the versatility to also humidify air in dry seasons, or fail to remove pollutants or contaminants. Additionally, renewable energy using wind mill set-up is usually located at off-site locations which is far from densely populated areas (such as buildings), where energy consumption is utilized. In such scenario, there is a huge loss of energy transmission from a off-site location to a locality with plurality of high-rise buildings. Thus, there exists a need to develop an improved apparatus, which would in turn address above mentioned variety of issues.

The above-described deficiencies of conventional approaches and method thereof, are merely intended to provide an overview of some of the problems of conventional approaches and are not intended to be exhaustive. Other problems with conventional approaches, and methods and their corresponding benefits of the various non-limiting embodiments described herein may become further apparent upon review of the following description.

### SUMMARY OF THE INVENTION

The following presents a simplified summary of the invention to provide a basic understanding of some aspects of the invention. This summary is not an extensive overview of the present invention. It is not intended to identify the key/critical elements of the invention or to delineate the scope of the invention. Its sole purpose is to present some concept of the invention in a simplified form as a prelude to a more detailed description of the invention presented later.

In one implementation, an apparatus for controlling ventilation in a building is disclosed. The apparatus comprises a sail member extending from each corner of the building to direct air flow from exterior potion of the building towards interior portion of the building. The apparatus comprises a first tubular member operationally coupled to a windward member of the building to direct the air flow in downward direction. Further, the apparatus comprises a second tubular member coupled to the first tubular member and a third tubular member, to increase the air flow received from the first tubular member, wherein the increased air flow is utilized to provide electricity to a ventilation mechanism installed within the building.

In another implementation, the second tubular member comprises one or more conversion device capable of converting energy driven from the air flow to electrical energy.

In yet another implementation, an internal portion of the first tubular member comprises a threaded portion to provide unidirectional air flow to the second tubular member.

In yet another implementation, method for controlling ventilation in a building is disclosed. The method comprises the step of penetrating, by a sail member extending from each corner of the building, an air flow into the building, wherein the sail member is configured to be blown parallel to direction of the air flow. The method further comprises the step of guiding, by a first tubular member operationally coupled to a windward member of the building, the air flow in downward direction. Furthermore, the method comprises the step of increasing, by a second tubular member coupled to the first tubular member and a third tubular member, the air flow received from the first tubular member, wherein the increased air flow is utilized to provide electricity to a ventilation mechanism for maintaining and controlling air ventilation of the building.

### Objectives

Some of the objects of the present disclosure, which at least one embodiment herein satisfies, are as follows:

An object of the present invention is to provide ventilation techniques for a building in such a way that the flow behavior within the building is further optimized so that the air conditioning of the entire building can be improved.

Another objective of the present invention is to dehumidify ambient air to adequately control temperature of the building.

Another objective of the present invention is to provide air conditioning systems to control indoor temperature, pressure, ventilation rate, and other variables.

Yet another objective of the present invention is to eliminate condensation problems with minimal or no reduction in air flow intensity within the building.

Yet another objective of the present invention is to provide dehumidification and cooling in seasons when the outdoor air is warm and humid can be used to provide humidification and heating in seasons when the outdoor air is cold and dry.

Other aspects, advantages, and salient features of the invention will become apparent to those skilled in the art from the following detailed description, which, details the invention in different embodiments.

### BRIEF DESCRIPTION OF THE DRAWINGS

While the specification concludes with claims that particularly point out and distinctly claim the invention, it is believed that the advantages and features of the present invention will become better understood with reference to the following more detailed description of expressly disclosed exemplary embodiments taken in conjunction with the accompanying drawings. The drawings and detailed description which follow are intended to be merely illustrative of the expressly disclosed exemplary embodiments and are not intended to limit the scope of the present invention as set forth in the appended claims. In the drawings:

FIG. 1 illustrates a schematic view of a building receiving air flow from multiple direction adopted in an embodiment of the invention; and

FIG. 2 illustrates a schematic side view of the tubular assembly adopted in an embodiment of the invention.

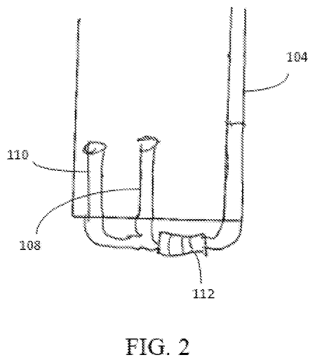

### LIST OF REFERENCE NUMERALS

100 Building
102 Sail Member
104 First Tubular Member
106 Plurality of Slots
108 Second Tubular Member
110 Third Tubular Member
112 Conversion Device

### DETAILED DESCRIPTION OF THE INVENTION

Embodiments, of the present disclosure, will now be described with reference to the accompanying drawing.

The exemplary embodiments described herein detail for illustrative purposes are subject to many variations in the structure and composition. It should be emphasized, however, that the present invention is not limited to a particular composition as shown and described herein. It is understood that various omissions and substitutions of equivalents are contemplated as circumstances may suggest or render expedient, but these are intended to cover the application or implementation without departing from the scope of the claims of the present invention. Also, it is to be understood that the phraseology and terminology used herein is for the purpose of description and should not be regarded as limiting.

The use of terms “including,” “comprising,” or “having” and variations thereof herein; are meant to encompass the items listed thereafter and equivalents thereof as well as additional items. Further, the use of the expression “at least” or “at least one” suggests the use of one or more elements or ingredients or quantities, as the use may be in the embodiment of the disclosure to achieve one or more of the desired objects or results. Further, the terms, “an” and “a” herein do not denote a limitation of quantity, but rather denote the presence of at least one of the referenced item. Furthermore, the term “may” herein is used in a permissive sense (i.e. meaning having the potential to), rather than the mandatory sense, (i.e. meaning must)

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention, and without any restriction regarding the possibility of combining the features introduced in such way with other optional or non-optional features of the invention.

The following detailed description illustrates the invention by way of example, and not by way of limitation. This description will clearly enable one skilled in the art to make and use the invention and describes several embodiments, adaptions, variations, alternatives, and uses of the invention, including what we presently believe is the best mode of carrying out the invention.

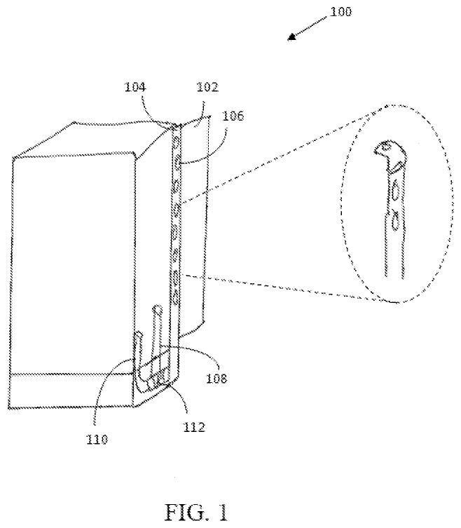

The present invention enables the indoor air of feeding or the air of discharge interior to be purified and well ventilated, to attain the effect of energy-conservation. Referring to FIG. 1, the present invention illustrates a schematic view of a building (100) receiving air flow from multiple direction. In one embodiment, an apparatus for controlling ventilation in the building is disclosed. The apparatus comprises a sail member (102) extending from each corner of the building is configured to be blown parallel to direction of air flow for penetrating the air flow into the building (100). For an instance, dimensions of the sail member (102) ranges from 1 m to 5 m to accumulate air flow from all possible directions.

In one case, the apparatus may comprise an extendible sliding member to cover the entire surface of the building (100). This is done so that it can shut down the heat and save fuel consumption of air conditioner in summer time, thereby providing heat insulation to the building (100). For example, bringing the 40 degrees down to 35 degree to save tremendous savings. In one case, sail member (100) or the extendible sliding member may be utilized as a hoarding to display advertisements.

Further, the apparatus may comprise a first tubular member (104) operationally coupled to a windward member of the building to guide the air flow in downward direction. It may be noted that that the first tubular member (104) may comprise a plurality of slots (106), as shown in zoomed in portion of FIG. 1, for receiving the air flow directed from the sail member (102). A plurality of slots (106) may be located at front portion, rear portion, or upward position of the first tubular member (104).

As generally understood, total volume of the air flow is dependent on the constant front air volume plus wind strength during sailing in the environment. In one embodiment, a processing engine (not shown) installed within the building (100) may determine a set of controlling parameters pertaining to an optimized size of the plurality of slots (106). For an instance, under gusty wind conditions, the set of controlling parameters may provide an optimal solution to control variable direction of wind flow around the building (100).

It is to be noted that the processing engine may be configured by a system having a machine learning technique, an artificial intelligence technique, a template approach technique, an artificial potential field technique, or the like, or any combination thereof to determine optimized size of the plurality of slots (106). In one embodiment, the artificial intelligence technique can also be employed to optimize each slot (110) to produce musical notes. For an instance, artificial intelligence technique may record and measure the air flow for controlling acoustic sound to generate sound like a tuba.

Further, the apparatus may comprise a second tubular member (108) to increase the air flow received from the first tubular member (104). In one case, the one end of the second tubular member (108) is coupled to the first tubular member (104) and its other end is coupled to a third tubular member (110). It may be noted that the second tubular member (108) may be installed beneath the building area. Further, there may be multiple tubular members coupled to the second tubular member (108). It may be noted that the second tubular member (108) may comprise at least one a conversion device (112), capable of creating high velocity airflow within the second tubular member (108).

In one case, the at least one conversion device (112) may correspond to a turbine generator (screw type), jet pump, or the like, installed within the second tubular member (108). It may be noted that as the second tubular member is installed underneath of the building, accordingly the rotating turbine set up is also installed in the underground of building to generating electricity. The conversion device (112) may convert air flow to mechanical energy, electrical energy, or a combination thereof. The mechanical energy created may include rotation of a turbine blade, a high velocity airflow, or other mechanical energy. Further, the energy may be utilized by a ventilation mechanism (not shown) for maintaining and controlling air ventilation of the building. In one case, the third tubular member (110) may be utilized to provide controlled amount of air flow to the building (100).

Further, if the wind directions get reversed, the air flow that travels internally within the building (100) would also reverse. Therefore, an elongated conduit, operationally coupled at top of the building (100), is capable of directing the reverse air flow within the building (100). Particularly, an emergency air release valve may be installed within proximity of the elongated conduit to release the air flow back to the environment in case of any emergency situations. In one embodiment, the apparatus may comprise plurality of air-filters to purify atmospheric air pollutants and odors from the air flow being supplied for ventilation of the building. Moreover, these air-filters are easy to install in the inlet of the building.

The wind sail can fold and cover up the screw pipes. This ensures that the pipe will not be affected by extreme wind speeds of more than 30-50 km per hour, such as in typhoon, cyclone and hurricane wind speeds.

The foregoing descriptions of exemplary embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present invention.

### Technical Advancements

The present invention described herein; above has several technical advantages including, but not limited to, enhancing the airflow and energy efficiency of the building that:
provides air conditioning systems to control indoor temperature, pressure, ventilation rate, and other variables;
is easy to use and economical in nature;
results into inexpensive setup; and
performs analysis based on artificial intelligence.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

I claim:

1. An apparatus for controlling ventilation in a building, the apparatus comprising:
a sail member extending from each corner of the building to direct air flow from exterior potion of the building towards interior portion of the building;
a first tubular member operationally coupled to a windward member of the building to guide the air flow in downward direction; and
a second tubular member coupled to the first tubular member and a third tubular member, to increase the air flow received from the first tubular member, wherein the increased air flow is utilized to provide electricity to a ventilation mechanism for maintaining and controlling air ventilation of the building,
wherein a ventilation mechanism is to maintain and control air ventilation of the building.

2. The apparatus as claimed in claim 1, wherein an internal portion of the first tubular member comprises a threaded portion to provide unidirectional air flow to the second tubular member.

3. The apparatus as claimed in claim 1, wherein the second tubular member comprises one or more conversion device capable of converting energy driven from the air flow to electrical energy.

4. The apparatus as claimed in claim 3, wherein the second tubular member (108) is installed underneath of the building.

5. A method for controlling ventilation in a building, the method comprising:
penetrating, by a sail member extending from each corner of the building, an air flow into the building, wherein the sail member is configured to be blown parallel to direction of the air flow;
guiding, by a first tubular member operationally coupled to a windward member of the building, the air flow in downward direction; and
increasing, by a second tubular member coupled to the first tubular member and a third tubular member, the air flow received from the first tubular member, wherein the increased air flow is utilized to provide electricity to a ventilation mechanism for maintaining and controlling air ventilation of the building,
wherein a ventilation mechanism is to maintain and control air ventilation of the building.
